(19) United States
(12) Patent Application Publication
(10) Pub. No.: US 2020/0260539 A1
(43) Pub. Date: Aug. 13, 2020

(54) SYSTEM AND METHOD FOR MICROWAVE DIGESTION OF A SAMPLE

(71) Applicant: SCP SCIENCE, Baie d'Urfe (CA)

(72) Inventors: George FEILDERS, Beaconsfield (CA); TechChhay KHUN, Montreal (CA); Guobin MA, Dorval (CA)

(21) Appl. No.: 16/786,343

(22) Filed: Feb. 10, 2020

Related U.S. Application Data
(60) Provisional application No. 62/804,438, filed on Feb. 12, 2019.

(51) Int. Cl. H05B 6/80; B01J 19/12

(52) U.S. Cl. CPC H05B 6/806; B01J 19/126; B01J 2219/00162; B01J 2219/1275; B01J 2219/00051

(57) ABSTRACT

The present disclosure provides methods and systems for performing a microwave digestion of a sample contained in a sample recipient. The method comprises acquiring images of at least one sample recipient inside a primary cavity of a microwave digestion system during microwave digestion of a sample inside the at least one sample recipient, and monitoring the microwave digestion using the images of the at least one sample recipient.

### CROSS-REFERENCE TO RELATED APPLICATIONS

The present application claims the benefit of U.S. Provisional Patent Application No. 62/804,438 filed on Feb. 12, 2019, the contents of which are hereby incorporated by reference.

### TECHNICAL FIELD

The present disclosure relates to microwave digestion systems, and more specifically to techniques and systems for monitoring microwave digestion.

### BACKGROUND OF THE ART

Microwave digestion is a technique used to dissolve certain substances into solutions of simple free atoms, for example heavy metals. Traditional approaches involve placing a sample in an open-ended recipient, which is then closed and heated in a microwave oven. Some digestion systems allow for the heating of a single sample at a time; other systems allow for the concurrent heating of multiple samples.

In some cases, a microwave digestion process can take a considerable amount of time, during which the sample is enclosed in a microwave digestion chamber or cavity. Existing monitoring systems make use of temperature or pressure sensors. There is a need for additional information regarding the reactions.

### SUMMARY

In accordance with a first broad aspect, there is provided a method performing microwave digestion of a sample contained in a sample recipient. The method comprises: placing the sample recipient within a primary cavity of a microwave digestion system; applying microwave energy to the sample in the sample recipient; acquiring, via an imaging device, images of the sample recipient inside the primary cavity during the microwave digestion; and monitoring the microwave digestion using the images of the sample recipient.

In some embodiments, the method comprises modifying one or more digestion parameters based on the monitoring of the microwave digestion using the images.

In accordance with another broad aspect, there is provided a system for performing microwave digestion of a sample contained in a sample recipient. The system comprises an outer structure having an inner surface and an outer surface, the inner surface defining a primary cavity; a microwave source communicatively coupled to the primary cavity; a separating structure inside the primary cavity defining a recess between the separating structure and the inner surface, the separating structure having an aperture formed therein, the aperture sized to prevent microwaves from the microwave source from entering the recess; and an imaging device disposed within the recess and aligned with the aperture for acquiring images of the sample recipient

In some embodiments, the system further comprises a control device coupled to the imaging device and configured for receiving the images of the sample recipient and monitoring the microwave digestion using the images.

In some embodiments, the control device is further configured for modifying one or more digestion parameters of the microwave digestion system based on the monitoring of the microwave digestion.

In accordance with yet another broad aspect, there is provided a control system for microwave digestion of a sample contained in a sample recipient. The control system comprises at least one processing unit and a non-transitory computer-readable medium having stored thereon program instructions. The program instructions are executable by the least one processing unit for acquiring images of the sample recipient inside a primary cavity of a microwave digestion system during the microwave digestion of the sample inside the sample recipient; monitoring the microwave digestion using the images of the sample recipient; and modifying one or more digestion parameters of the microwave digestion system based on the monitoring of the microwave digestion and on a comparison of the images to past digestions through machine learning.

Features of the systems, devices, and methods described herein may be used in various combinations, and may also be used for the system and computer-readable storage medium in various combinations

### BRIEF DESCRIPTION OF THE DRAWINGS

Further features and advantages of embodiments described herein may become apparent from the following detailed description, taken in combination with the appended drawings, in which:

FIG. 1 is a perspective cutaway view of an example microwave digestion system, in accordance with an illustrative embodiment;

FIGS. 2A-2B are top cutaway views of different configurations of the microwave digestion system of FIG. 1, in accordance with an illustrative embodiment;

FIG. 3 is perspective cutaway view of an example primary cavity of an example microwave digestion system, in accordance with an illustrative embodiment;

FIG. 4 is a top cutaway view of the primary cavity of FIG. 3, in accordance with an illustrative embodiment;

FIG. 5 is zoomed top cutaway view of an example secondary cavity of the primary cavity of FIG. 3, in accordance with an illustrative embodiment; and

FIG. 6 is a block diagram of an example computing device.

It will be noted that throughout the appended drawings, like features are identified by like reference numerals.

### DETAILED DESCRIPTION

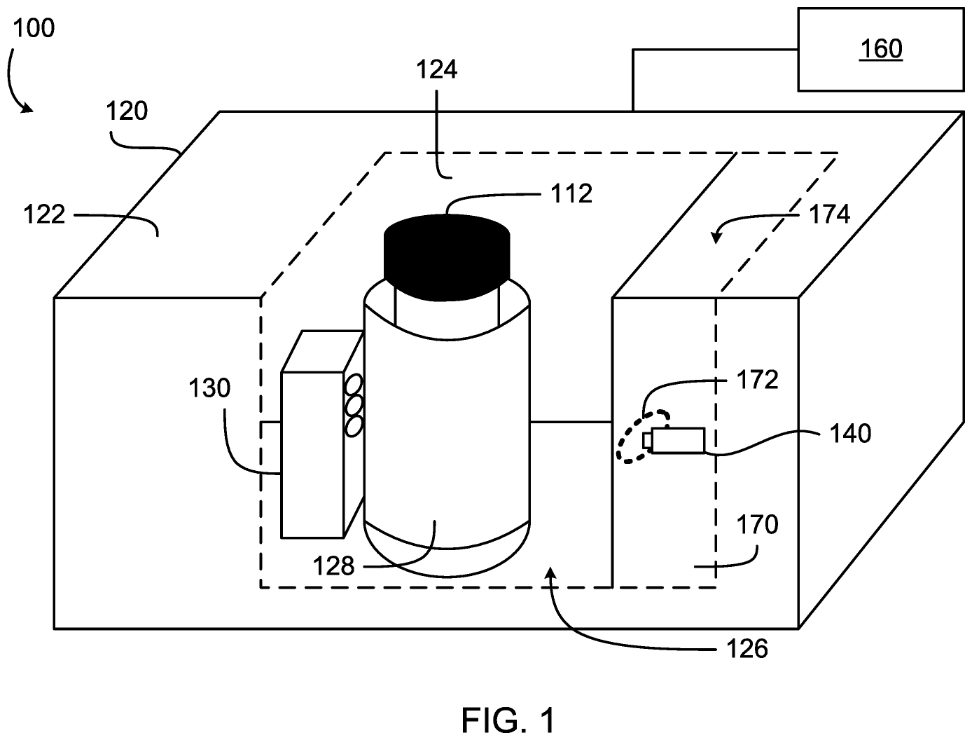

With reference to FIG. 1, there is shown an example embodiment of a microwave digestion system 100 for performing microwave-based digestion of samples contained in sample recipients, illustrated at 112. The microwave digestion system 100 is generally composed of an outer structure 120, a microwave device 130, and an imaging device 140. In some embodiments, the microwave device 130 and/or the imaging device 140 can be wholly or in part contained within the outer structure 120, as detailed herein below. Alternatively, the microwave device 130 and/or the imaging device 140 can be disposed outside the outer structure 120, for example being adjacent thereto. As used herein, the expression “imaging device” is used to refer to any type of image sensor that detects and conveys information used to make an image. In some embodiments, the image is generated locally to the microwave digestion system 100. In some embodiments, the image is generated remotely to the microwave digestion system 100. The imaging device 140 may be analog or digital, electronic or optical. In some embodiments, the imaging device 140 is a digital camera, an infrared camera, a thermal camera, a charge-coupled device, or an active pixel sensor (i.e. CMOS sensor). An optical fiber or other cable may also be used as part or all of the imaging device 140.

The microwave digestion system 100 can be communicatively coupled to a control device 160, which can be used to control output of the microwave device 130 and/or image acquisition by the imaging device 140. The control device 160 can be any suitable computer or computing device, as appropriate, for example a desktop or laptop computer, a mobile computing device, a server or mainframe, an embodied microprocessor and the like. Coupling of the control device 160 to the microwave digestion system 100 can be performed using any suitable wired or wireless communication techniques.

The sample recipients 112 can take on any suitable size and shape, and can be formed of any suitable material. For example, the sample recipients 112 are formed of quartz, Teflon™, or any other material which is partially or substantially transparent to light in the visible to infrared spectrum. In some embodiments, for example as illustrated in FIG. 1, the microwave digestion system 100 is configured for accommodating a single sample recipient 112. In other embodiments, the microwave digestion system 100 is configured for concurrently accommodating a plurality of sample recipients 112

The outer structure 120 has an outer surface 122 and an inner surface 124. The inner surface 124 of the outer structure 120 defines one or more primary cavities 126 in which the sample recipient(s) 112 are disposed. In some embodiments, for example as shown in FIG. 1, the outer structure 120 defines a single primary cavity 126, in which one or more sample recipients 112 can be disposed. In other embodiments, the outer structure 120 can define a plurality of primary cavities 126, and each one of the primary cavities 126 can receive one or more of the sample recipients 112. In some other embodiments, the primary cavity 126 can be formed in part by the outer structure 120, in conjunction with additional elements which can be mated with the outer structure 120, including a lid or cover, a rack or other support for the sample recipients 112, and the like. In some embodiments, the sample recipient 112 can be supported within the primary cavity 126 by a recipient-supporting structure 128. The recipient-supporting structure 128 can, for example, be used to ensure that the sample recipient maintains a particular upright orientation. The recipient-supporting structure 128 can be made of a transparent material, or can have formed therein one or more openings, to allow the state of the sample within the sample recipient 112 to be visible through the recipient-supporting structure 128, and to permit the transmission of microwaves from the microwave device 130 to the sample contained in the sample recipient 112.

Whether formed by the outer structure 120 or by mating of the outer structure 120 with additional elements, the primary cavity 126 substantially encloses one or more of the sample recipients 112. In operation, the microwave digestion system 100 subjects the sample recipients 112 to microwave radiation from the microwave device 130, and the primary cavity 126 is configured for substantially enclosing at least part of the sample recipients 112 such that the microwave radiation to which the sample recipients 112 are subjected is substantially contained within the primary cavity 126. Put differently, the primary cavity 126 is designed to minimize or reduce the degree to which microwave radiation can leak or otherwise escape from the primary cavity 126.

The microwave device 130 of the microwave digestion system 100 can be any suitable type of microwave device, for example, a waveguide, an antenna, or the like, and can be communicatively coupled to the primary cavity 126 for providing microwave radiation thereto. The microwave radiation produced by the microwave device 130 can be of any suitable intensity, frequency or wavelength, and can be produced substantially continuously, in accordance with a predetermined pattern, or in any suitable fashion. The microwave device 130 can be disposed at any suitable location within the outer structure 120, or can be partially positioned outside the outer structure 120: for instance, a source of microwaves can be positioned adjacent to the outer structure 120, and a waveguide or other similar structure can be used to direct the microwaves to the primary cavity 126.

Inside the outer structure 120 is disposed one or more separating structures 170, which can be integrally formed with the outer structure 120, or formed separately therefrom. Each separating structure 170 defines one or more recesses 174 in which the imaging device 140 is disposed. The recess 174 can be of any suitable size and shape for receiving the imaging device 140, and can be disposed at any suitable location within the outer structure 120 so that the field of view of the imaging device 140 encompasses the sample recipient 112, when the imaging device 140 is disposed within the recess 174. The recess 174 is separated from the primary cavity 126 by the separating structure 170, which can have defined therein an aperture 172.

The imaging device 140 can be any suitable device which is capable of acquiring still images and/or video across any suitable range of wavelengths, for example the visible spectrum, and can be implemented using any suitable technology. In some embodiments, the imaging device 140 is also capable of acquiring sound. The imaging device 140 can be arranged within the recess 174 so that the imaging device 140 is aligned with the aperture 172 in the separating structure 170. In this fashion, the imaging device 140 is able to see beyond the recess 174, through the aperture 172 in the separating structure 170, for example to acquire images of the sample recipient 112. The field of view of the imaging device 140 encompasses at least one of the sample recipients 112.

The aperture 172 can be of any suitable size for facilitating the acquisition of images by the imaging device 140 therethrough. In addition, the aperture 172 can be sized to prevent microwaves produced by the microwave device 130 from entering the recess 174 through the aperture 172. The size of the aperture 172 can be determined based on the wavelength of the microwaves produced by the microwave device 130: for example, if the microwave device 130 produces microwaves having a wavelength of approximately 122 mm, the aperture 172 can be roughly 3 mm or less in diameter. Other sizes for the aperture 172 can be considered, based on the wavelength of the microwaves produced by the microwave device 130. Having the imaging device 140 within the recess 174 separates the imaging device from the primary cavity 126, via the separating structure 170, which reduces the exposure of the imaging device 140 to microwave radiation produced by the microwave device 130. By providing the aperture 172 in the separating structure 170 and by appropriately positioning the imaging device 140, the imaging device 140 can be used to acquire images of one or more of the sample recipients 112. In addition, because the aperture 172 is sized so as to prevent the transmission of microwaves from the primary cavity 126 to the recess 174, the imaging device remains substantially protected from microwave radiation.

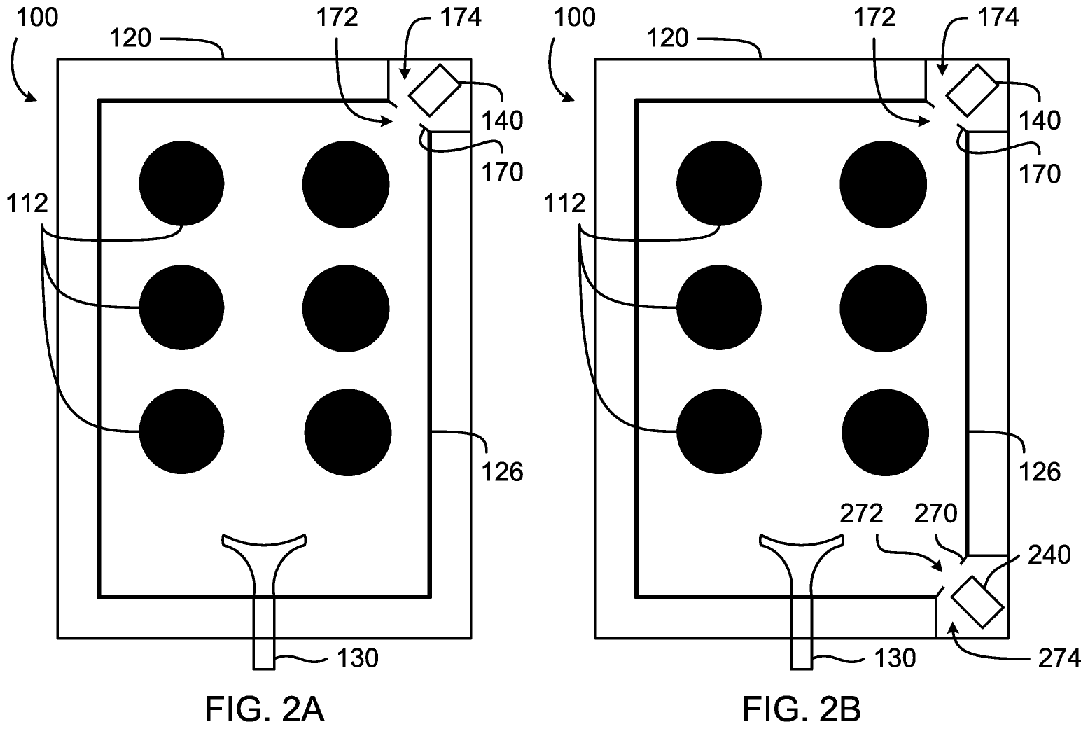

With reference to FIGS. 2A-2B, in some embodiments the primary cavity 126 is formed for receiving a plurality of sample recipients 112. The primary cavity 126 can receive any suitable number of sample recipients 112, for example six (6) as shown in FIGS. 2A-2B. In FIG. 2A, a single recess 174 is formed in the outer structure 120, and the imaging device 140 is placed within the recess 174 for acquiring images of the sample recipients 112 through the aperture 172. In some embodiments, the imaging device 140 is provided with a wide field of view, for instance by shaping the aperture 172 in a suitable fashion, so that the imaging device 140 can acquire images of each of the sample recipients 112 substantially simultaneously. Alternatively, the imaging device 140 can be mounted on a motor or other device for moving the imaging device 140 to alter the field of view of the imaging device 140. Alternatively still, the imaging device 140 can be substantially stationary, and the sample recipients 112 can be mounted on a motorized platform or a movable stand and caused to move into the field of view of the imaging device 140. Still other approaches are considered. In one example, part of the outer structure 120 is movable, and the imaging device 140 is affixed to a moveable portion of the outer structure 120. When the movable portion of the outer structure 120 is brought in proximity to the sample recipient 112, the imaging device 140 becomes positioned such that the sample recipient 112 is within the field of view of the imaging device 140. Other examples are also considered.

In FIG. 2B, an additional separating structure 270 is formed within the outer structure 120, defining a recess 274. The separating structure 270 has formed therein an aperture 272, and imaging device 240 is disposed within the recess 274. The imaging devices 140, 240 can each be positioned for acquiring images of all of the sample recipients 112, or can be positioned to each acquire images of some of the sample recipients 112. Other embodiments of the microwave digestion system 100 can include any suitable number of recesses, which can be positioned at suitable locations within the outer structure 120.

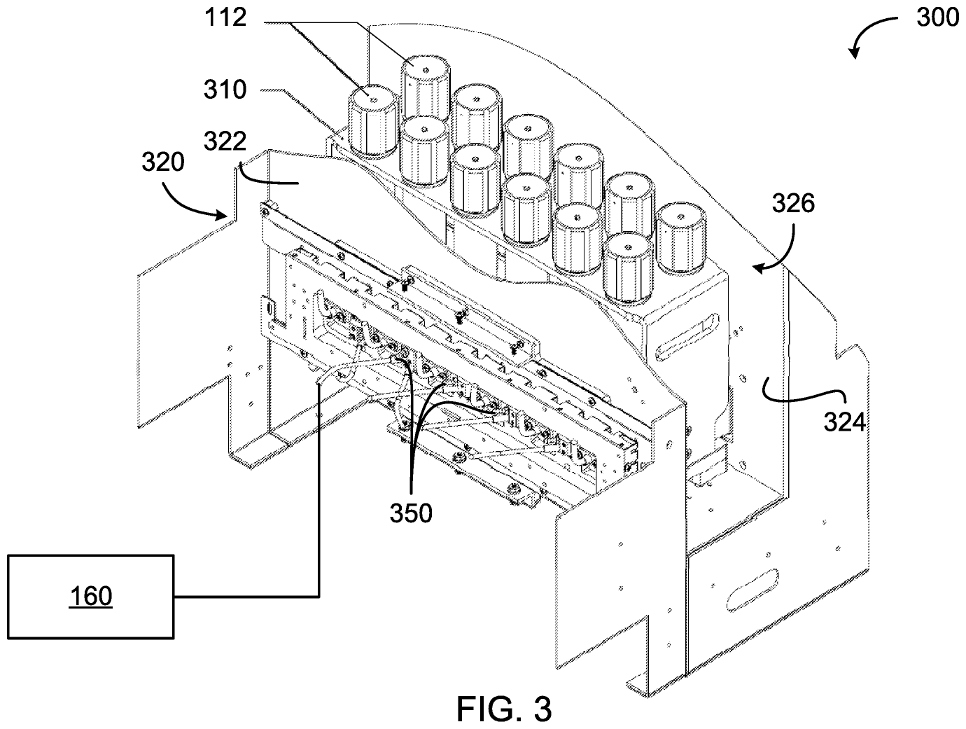

With reference to FIG. 3, a particular embodiment of a microwave digestion system 300 is shown. The microwave digestion system 300 is composed of an outer structure 320 having an outer surface 322 and an inner surface 324. Sample recipients 112 are supported by a sample rack 310, which can be inserted in a primary cavity 326 within the outer surface 322. The sample rack 310 can be used, for example, to ensure a particular upright orientation of the sample recipients 112. In addition, the sample rack 310 can facilitate handling of multiple sample recipients 112. In this embodiment, the primary cavity 326 can accommodate twelve (12) sample recipients 112. It should be noted that other configurations are considered, including with fewer, or more, sample recipients, and the primary cavity 326 can be sized to accommodate any particular arrangement of the sample recipients 112.

Optionally, the microwave digestion system 300 can further include a ventilation and active cooling system for providing ventilation and cooling to one or more components of the microwave digestion system 300. In some embodiments, the ventilation system is composed of one or more compressed air nozzles 350, which distribute compressed room temperature or low temperature air throughout the primary cavity 326. In other embodiments, other types of ventilation and cooling systems are considered, such as one or more fans, one or more heatsinks, and the like.

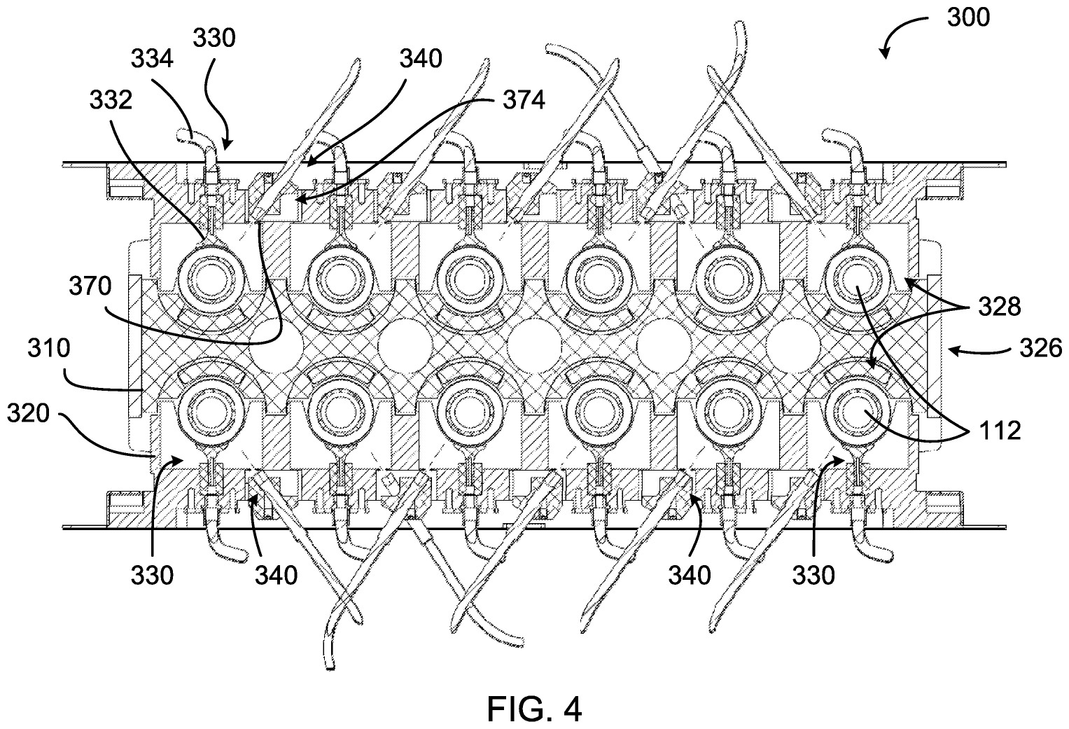

With additional reference to FIG. 4, the sample rack 310 can be received within the outer structure 320 of the microwave digestion system 300. A door at each end of cavity 326 may be closed after the sample rack 310 is placed inside the primary cavity. In some embodiments, there is one door for cavity 326. In some embodiments, there are two or more doors for cavity 326. In some embodiments, the sample rack 310 is mateable with parts of the inner surface 324 of the outer structure 320, for example to form the primary cavity 326, and/or to form one or more secondary cavities 328 within the primary cavity 326. For instance, the sample rack 310 is positioned within the outer structure 320 by an operator or automated machine, and the sample rack 310 is caused to mate with the moveable part of the outer structure 320, thereby forming the secondary cavities 328 which enclose the sample recipients 112. In other embodiments, part or all of the outer structure 320 is located within a larger enclosure and mounted on movable arms. The sample rack 310 is placed on a conveyor belt or similar device and is moved into the larger enclosure. The outer structure 320 is displaced to mate with the sample rack 310, thereby forming the secondary cavities 328 which enclose the sample recipients 112. In some instances, the mating of the sample rack 310 with the outer structure 320 is performed at least in part via an interlocking mechanism. In still further embodiments, a cover can be placed over a top portion of the outer structure 320 to enclose the sample recipients 112 within the primary cavity 326. In some embodiments, the cover can be made to interlock with the outer structure 320, using any suitable mechanism.

As described hereinabove, the primary cavity 326, much like the primary cavity 126, serves to enclose one or more sample recipients 112. The primary cavity 126 also serves to substantially contain the microwave radiation transmitted via the microwave devices 330, such that the amount of microwave radiation leaking outside the primary cavity is limited. In embodiments in which one or more secondary cavities 328 are formed within the primary cavity 326, these secondary cavities 328 are configured for enclosing a subset of the total number of sample recipients 112 present within the primary cavity: for instance, each secondary cavity 328 can enclose a single sample recipient, or two or more of the sample recipients 112. As described in greater detail hereinbelow, the microwave radiation applied to each of the secondary cavities 328 can be individually selected, or otherwise varied from one secondary cavity 328 to the next. Alternatively, or in addition, each of the secondary cavities 328 can have a different number of imaging devices 340 associated therewith, for instance to allow for differing monitoring of the samples to be performed in each of the secondary cavities 328. In addition, by situating the secondary cavities 328 within the primary cavity 326, the primary cavity 326 can serve as a safeguard against any microwave radiation which may leak from the secondary cavities 328.

The microwave digestion system 300 further comprises microwave devices 330 and imaging devices 340. As shown in FIG. 4, the microwave digestion system 300 can define a plurality of secondary cavities 328, each associated with a respective sample 112, and formed by the mating of the outer structure 320 with the sample rack 310. It should be noted that in other embodiments, the secondary cavities 328 can be formed solely by the outer structure 320, as appropriate.

Communicatively coupled to each of the secondary cavities 328 is a microwave device 330, which is composed of a microwave emitter 332 and a cable 334. The microwave emitters 332 can be any suitable device for transmitting microwaves, for example as produced by a magnetron or other microwave source. The cables 334, which can be coaxial cables, are configured for providing an input to the microwave emitters 332, which then transmit the microwaves input from the cable 334. In other embodiments, the microwave devices 330 can consist of magnetrons which directly produce microwave radiation, and which can be controlled via cables or other means, as appropriate. In other embodiments, the microwave devices 330 can be a waveguide(s) connected to one or more magnetron. The microwave devices 300 can produce microwaves substantially continuously during operation, and can vary the output of microwaves according to predetermined output patterns, or in response to operator controls, for example substantially in real-time. In some embodiments, the production of microwaves by the microwave emitters 332 is controlled by the control device 160.

The outer structure 320 also defines one or more recesses 374 in which the imaging device 340 is disposed. The recesses 374 can be substantially similar to the recesses 174 described hereinabove, can be of any suitable size and shape, and can be disposed at any suitable location within the outer structure 320. The recesses 374 are formed within the primary cavity 326 by separating structures 370, which can have defined therein an aperture. The imaging device 340 can be arranged within the recess 374 so that the imaging device 340 is aligned with the aperture in the separating structure 370. In this fashion, the imaging device 340 is able to see beyond the recess 374, through the aperture in the separating structure 370, for example to acquire images of the sample recipient 112.

In some embodiments of the microwave digestion system 300, the outer structure 320 and the sample rack 310 define multiple secondary cavities 328. In such embodiments, the outer structure 320 can define multiple recesses 374 via multiple separating structures 370. For example, a number of recesses 374 equivalent to the number of secondary cavities 328 are defined in the outer structure 320, and each recess 374 is provided with an imaging device 340. Each of the imaging devices 340 is assigned a corresponding one of the secondary cavities 328, so that the imaging devices 340 each acquire images of a respective one of the sample recipients 112. In another example, the outer structure 320 can define fewer, or more, recesses 374 than the number of secondary cavities 328, with imaging devices 340 in the recesses 374 configured for acquiring images of multiple ones of the sample recipients 112, or multiple ones of the imaging devices 340 being configured for concurrently acquiring images of particular ones of the sample recipients 112. It should also be noted that in certain embodiments, the recesses 374 can be formed within the sample rack 310, with the imaging devices 340 being disposed therewithin.

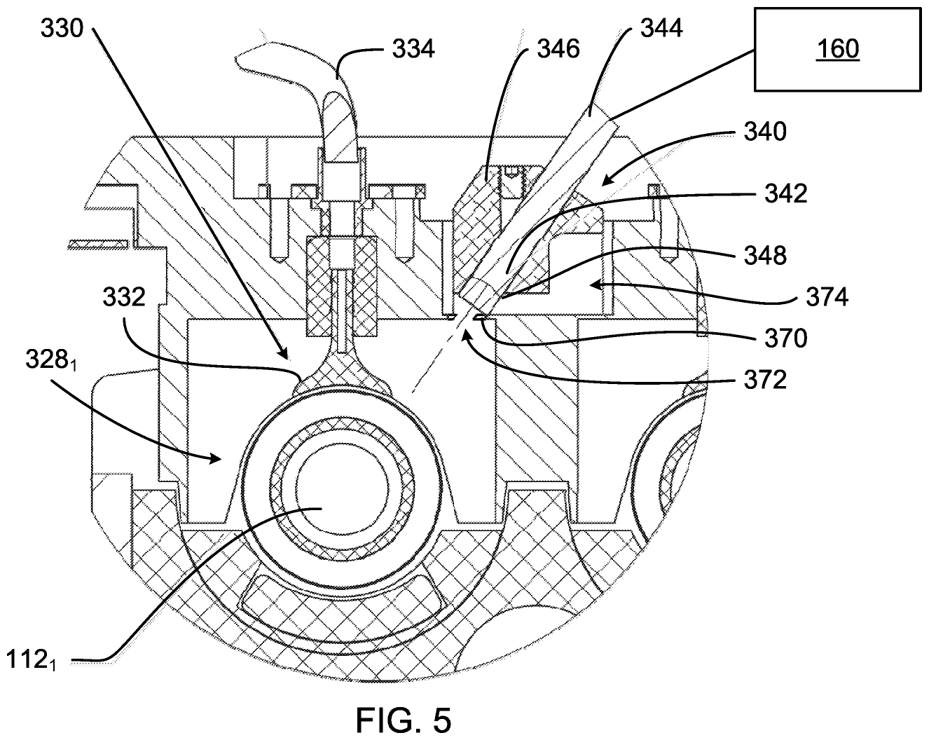

With additional reference to FIG. 5, a particular one of the secondary cavities 328, illustrated as secondary cavity 328₁ and enclosing a particular sample recipient 112₁, is illustrated. The imaging device 340 is disposed within the recess 374 and separated from the secondary cavity 328₁ by the separating structure 370, which has formed therein the aforementioned aperture 372. The imaging device 340 is composed of a camera 342 coupled to a connecting cable 344, which communicatively couples the camera 342 to the control device 160, which can include any suitable image processing capabilities. In some embodiments, a bracket 346 is provided in the recess 374 for retaining the camera 342 and/or the cable 344 within the recess 374. Alternatively, or in addition, the bracket 346 can ensure the positioning of the camera 342 so that the camera 342 can acquire images of particular ones of the sample recipients 112, for instance the sample recipient 112₁, through the aperture 372. It should be noted that other embodiments for the imaging device 340 are considered.

Optionally, the imaging device 340 further includes a light source 348 for illuminating the sample recipient 112₁. The light source 348 can produce light in the visible spectrum, of any suitable colour, including white light, or in any other spectrum, such as ultraviolet (UV) or infrared (IR). In some embodiments, the light source 348 is substantially co-located with the camera 342. For instance, when the light source 348 is sensitive to microwave radiation, placing the light source 348 in the recess 374 can reduce the impact of microwaves produced by the microwave emitter 332 on the light source 348. In other embodiments, the light source 348 is located elsewhere within outer structure 320, for instance within the primary cavity 326 and/or within one of the secondary cavities 328. For instance, the camera 342 and the light source 348 can be disposed in separate ones of the recesses 374, with respective apertures 372 sized to prevent microwaves from entering the recesses 374.

In embodiments in which the outer structure 320 is substantially static, the imaging device 340, which is disposed within the recess 374, also remains substantially static. In other embodiments in which the outer structure 320 (or a part thereof) is movable, for instance for mating with the sample rack 310, the imaging device 340 are movable with the outer structure 320. For instance, the outer structure 320 can be mounted to a movable arm, and the cable 344 can be attached to, or otherwise coupled to, the movable arm, such that the imaging device 340 is movable with the outer structure 320. Other approaches are also considered.

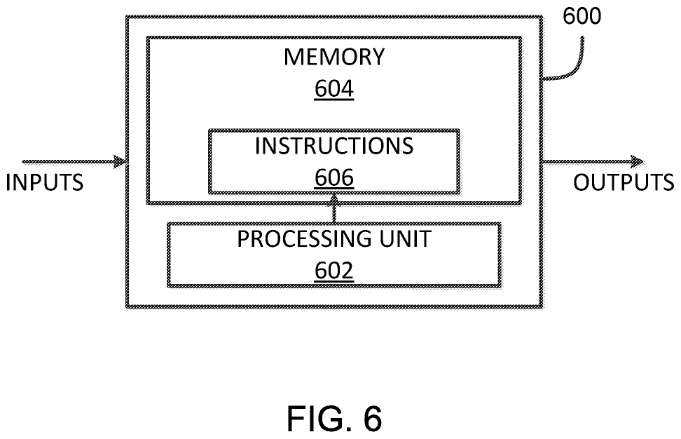

As stated above, the control device 160 can be any suitable computer or computing device, as appropriate. With reference to FIG. 6, an example of a computing device 600 for implementing the control device 160 is illustrated. The control device 106 may be implemented with one or more computing devices 600.

The computing device 600 comprises a processing unit 602 and a memory 604 which has stored therein computer-executable instructions 606. The processing unit 602 may comprise any suitable devices configured to implement the method 400 such that instructions 606, when executed by the computing device 600 or other programmable apparatus, may cause the functions/acts/steps as described herein to be executed. The processing unit 602 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 604 may comprise any suitable known or other machine-readable storage medium. The memory 604 may comprise non-transitory computer readable storage medium, for example, but not limited to, an electronic, magnetic, optical, electromagnetic, infrared, or semiconductor system, apparatus, or device, or any suitable combination of the foregoing. The memory 604 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 602.

In some embodiments, a display device is coupled to the control device 160 for displaying one or more of the images captured before, during, and/or after microwave digestion. The images as displayed may be used by an operator of the microwave digestion system 100 to control the microwave digestion.

Alternatively, or in combination therewith, the control device 160 is provided with monitoring capabilities. For example, various machine learning algorithms and/or features may be implemented into the control device 160 in order to replace and/or complement an operator of the microwave digestion system 100. Information obtained from the monitoring of the images may be used to modify one or more digestion parameter in real-time using an artificial intelligence approach.

In some embodiments, characteristics of the images as acquired are used to assess various aspects of the microwave digestion. The characteristics may be related to color, vapor formation, liquid levels, the formation of solid particles, and the like. Some example characteristics are sample color, sample/reagent liquid level inside the sample recipient, air bubbles, and visible solid pieces inside the sample/reagent liquid. In some embodiments, venting events are detected, for example by detecting a certain amount of vapor in the form of bubbles. An expected venting event or color change may be indicative that a digestion is completed. An unexpected venting event or color change may be indicative of a problem or issue with the digestion, such as a defective or malfunctioning vessel cap.

The control device 160 may be configured to compare the characteristics as detected in the images to a set of reference images in order to determine a likelihood of a given condition associated with the microwave digestion, through artificial intelligence algorithms. The condition may be a positive outcome, such as completion of the microwave digestion. In this case, the microwave digestion may be terminated ahead of time, thus saving resources and increasing productivity. The condition may be negative, such as detecting a failed digestion. The condition may be neither positive nor negative, such as an increased temperature, a low level of liquid, a large amount of vapor, etc. In a case where a digestion is incomplete within a predefined time, the control device 160 may automatically increase the digestion time for a complete digestion.

In some embodiments, the control device 160 is configured to issue an alert or other type of signal when the microwave digestion deviates from an expected course. For example, an audible alarm, a text message, or another form of messaging may be used. Alternatively, or in combination therewith, the control device 160 is configured to modify one or more digestion parameter in response to detecting that the microwave digestion is deviating from an expect course. Example parameters that may be modified are an amount of power/energy delivered to the sample, a speed at which the power is delivered, a sample temperature, a sample temperature ramp time, a holding temperature, a holding time, a sample pressure, etc. Other parameters may also apply, depending on practical implementation.

In one specific and non-limiting example, most samples of lubricating grease are digested at a weight of 0.8 grams. These samples are quite exothermic and may vent if the sample weight is higher. The samples may also vent if shorter molecular chains are present due to degradation. The images may be used to determine a ratio of bubbles formed to solid background of the liquid in order to detect venting. In response to detecting the venting, the digestion parameters may be modified to reduce the venting.

In another specific and non-limiting example, in the case of a soil sample, a variation in color of the sample may be indicative of an inappropriate temperature setting. The microwave energy applied to the sample may be increased to ensure all samples are digested at a same temperature, or a given channel may be turned off to one specific sample that may be overheating.

In yet another specific and non-limiting example, when a sample starts at room temperature, the acid concentration is typically clear, then goes very dark with the formation of nitrogen oxides. The sample gets charred and then clears up to a clear straw color. These color changes may be monitored and detected in real time. If the sample has not reached the expected color after a pre-set digestion time, the digestion time may be prolonged. If the sample reaches the expected color before the pre-set digestion time, the digestion may be deemed completed and the microwave energy shut-off.

The methods and systems for microwave digestion described herein may be implemented in a high level procedural or object oriented programming or scripting language, or a combination thereof, to communicate with or assist in the operation of a computer system, for example the computing device 600. Alternatively, the methods and systems for microwave digestion may be implemented in assembly or machine language. The language may be a compiled or interpreted language. Program code for implementing the methods and systems for microwave digestion may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for microwave digestion may also be considered to be implemented by way of a non-transitory computer-readable storage medium having a computer program stored thereon. The computer program may comprise computer-readable instructions which cause a computer, or more specifically the processing unit 602 of the computing device 600, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Various aspects of the microwave digestion system disclosed herein may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. A method for performing microwave digestion of a sample contained in a sample recipient, the method comprising:
placing the sample recipient within a primary cavity of a microwave digestion system;
applying microwave energy to the sample in the sample recipient;
acquiring, via an imaging device, images of the sample recipient inside the primary cavity during the microwave digestion; and
monitoring the microwave digestion using the images of the sample recipient.

2. The method of claim 1, wherein monitoring the microwave digestion comprises at least one of detecting a change in color of the sample and detecting a venting event of the sample.

3. The method of claim 1, wherein monitoring the microwave digestion comprises determining whether the microwave digestion is completed.

4. The method of claim 1, further comprising modifying one or more digestion parameters based on the monitoring of the microwave digestion using the images.

5. The method of claim 4, wherein modifying one or more digestion parameters comprises increasing or decreasing microwave energy generated by the microwave source.

6. The method of claim 5, wherein modifying one or more digestion parameters comprises terminating the microwave digestion.

7. The method of claim 1, further comprising displaying at least some of the images via a display device outside the primary cavity.

8. The method of claim 1, further comprising shielding the imaging device from the microwave energy behind a separating structure inside the primary cavity, the separating structure having an aperture formed therein, the aperture sized to block the microwave energy.

9. A system for performing microwave digestion of a sample contained in a sample recipient, the system comprising:
an outer structure having an inner surface and an outer surface, the inner surface defining a primary cavity;
a microwave source communicatively coupled to the primary cavity;
a separating structure inside the primary cavity defining a recess between the separating structure and the inner surface, the separating structure having an aperture formed therein, the aperture sized to prevent microwaves from the microwave source from entering the recess; and
an imaging device disposed within the recess and aligned with the aperture for acquiring images of the sample recipient.

10. The system of claim 9, further comprising a control device coupled to the imaging device and configured for receiving the images of the sample recipient and monitoring the microwave digestion using the images.

11. The system of claim 10, wherein monitoring the microwave digestion using the images comprises detecting at least one of a color change and a venting event.

12. The system of claim 10, wherein the control device is further configured for modifying one or more digestion parameters based on the monitoring of the microwave digestion using the images.

13. The system of claim 12, wherein modifying one or more digestion parameters comprises modifying any one of time, energy, temperature, and pressure parameters of the microwave digestion.

14. The system of claim 9, further comprising a display device outside of the primary cavity for displaying at least some of the images of the microwave digestion.

15. A control system for microwave digestion of a sample contained in a sample recipient, the control system comprising at least one processing unit and a non-transitory computer-readable medium having stored thereon program instructions, the program instructions executable by the least one processing unit for:
acquiring images of the sample recipient inside a primary cavity of a microwave digestion system during the microwave digestion of the sample inside the sample recipient;
monitoring the microwave digestion using the images of the sample recipient; and
modifying one or more digestion parameters of the microwave digestion system based on the monitoring of the microwave digestion and on a comparison of the images to past digestions through machine learning.

16. The control system of claim 15, wherein monitoring the microwave digestion comprises detecting at least one of a change in color and a venting event.

17. The control system of claim 15, wherein monitoring the microwave digestion comprises determining whether the microwave digestion is completed.

18. The control system of claim 15, wherein modifying one or more digestion parameters comprises increasing or decreasing microwave energy generated by a microwave source of the microwave digestion system.

19. The control system of claim 15, wherein modifying one or more digestion parameters comprises terminating the microwave digestion.

20. The control system of claim 15, wherein the program instructions are further executable for displaying at least some of the images via a display device outside the primary cavity.
